(19) United States
(12) Patent Application Publication
(10) Pub. No.: US 2006/0007173 A1
(43) Pub. Date: Jan. 12, 2006

(54) Combined digitizer tablet and external power supply device for an electronic apparatus

(76) Inventors: Sung-Lin Tsai, Tao-Yuan Hsien (TW); Jung-Chung Chen, Pei-Te City (TW); Yum-Ming Yu, Hsi-Chih City (TW); Chun-Ming Wu, Tu-Cheng City (TW); Yi-Cheng Chang, Taipei City (TW)

Correspondence Address: TROP PRUNER & HU, PC, 8554 KATY FREEWAY, SUITE 100, HOUSTON, TX, 77024, US

(21) Appl. No.: 10/874,950

(22) Filed: Jun. 23, 2004

(51) Int. Cl. G09G 5/00

(52) U.S. Cl. 345/173

(57) ABSTRACT

A combined digitizer tablet and external power supply device for an electronic apparatus includes a housing, a battery unit disposed in the housing, and a sensing tablet unit disposed on the housing and that generates electrical signals in response to writing activity thereon. A control circuit is coupled electrically to the sensing tablet unit and the battery unit, and receives the electrical signals from the sensing tablet unit to generate corresponding coordinate position data. A data communications unit establishes a communications link with the electronic apparatus to transmit the coordinate position data thereto. A power output unit is coupled electrically to the control circuit, and enables electrical coupling to the electronic apparatus. The control circuit controls the supply of battery power from the battery unit to the electronic apparatus via the power output unit.

### BACKGROUND OF THE INVENTION

1. Field of the Invention

The present invention relates to a peripheral device for an electronic apparatus, more particularly to a combined digitizer tablet and external power supply device for application to an electronic apparatus.

2. Description of the Related Art

Digitizer tablets are used by computer users desiring an ability to input information by hand. Digitizer tablets also have other applications, such as in electronic dictionaries. Such digitizer tablets are becoming increasingly common as handwriting recognition technology improves, and as they are used for an ever-increasing range of applications.

Another device experiencing increased growth in usage is the external power supply. Portable electronic apparatuses, such as laptop computers, are typically equipped with internal rechargeable batteries. However, a common problem encountered by users of portable electronic apparatuses is the limited run time provided by the batteries mounted in the device. If there is no power outlet to plug into, the user has no choice but to discontinue further use of the apparatus. One way in which users of portable electronic apparatuses overcome this problem is to use an external power supply device that typically plugs into the DC adaptor socket. This enables continued use of the portable electronic apparatus.

With respect to the digitizer tablet, a drawback of this device is that when the electronic apparatus is not connected to an AC power outlet, the digitizer tablet draws power from the internal rechargeable batteries of the apparatus to which it is connected, thereby exacerbating the problem of limited run time. Furthermore, when the user of the electronic apparatus desires to employ both the digitizer tablet and the external power supply, connection of these units separately makes the area around the electronic apparatus disorganized, and reduces the portability of the electronic apparatus.

### SUMMARY OF THE INVENTION

Therefore, the object of the present invention is to provide a combined digitizer tablet and external power supply device for an electronic apparatus that minimizes an adverse affect on the portability of the electronic apparatus through the merging of these two devices, and that uses its own power to run the digitizer tablet.

According to the present invention, a combined digitizer tablet and external power supply device for an electronic apparatus includes a housing having a working surface. A sensing tablet unit is disposed on the working surface of the housing, and is operable so as to generate electrical signals in response to writing activity thereon. A battery unit is disposed in the housing. A control circuit is coupled electrically to the sensing tablet unit and the battery unit, and receives the electrical signals from the sensing tablet unit to generate coordinate position data corresponding to the electrical signals.

A data communications unit is mounted in the housing. The data communications unit is coupled electrically to the control circuit, and is adapted to establish a communications link with the electronic apparatus so as to enable transmission of the coordinate position data from the control circuit to the electronic apparatus.

A power output unit is mounted in the housing. The power output unit is coupled electrically to the control circuit, and is adapted to be coupled electrically to the electronic apparatus. The control circuit is operable so as to control the supply of battery power from the battery unit to the electronic apparatus via the power output unit.

### BRIEF DESCRIPTION OF THE DRAWINGS

Other features and advantages of the present invention will become apparent in the following detailed description of the preferred embodiment with reference to the accompanying drawings, of which:

FIG. 1 is a perspective view of a combined digitizer tablet and external power supply device for an electronic apparatus according to a preferred embodiment of the present invention, in which the combined digitizer tablet and external power supply is shown connected to an electronic apparatus;

FIG. 2 is a perspective view of the preferred embodiment;

FIG. 3 is a schematic view to illustrate a control circuit and a battery unit of the preferred embodiment;

FIG. 4 is a schematic circuit block diagram of the preferred embodiment; and

FIG. 5 is a schematic circuit block diagram of a control circuit of the preferred embodiment.

### DETAILED DESCRIPTION OF THE PREFERRED EMBODIMENTS

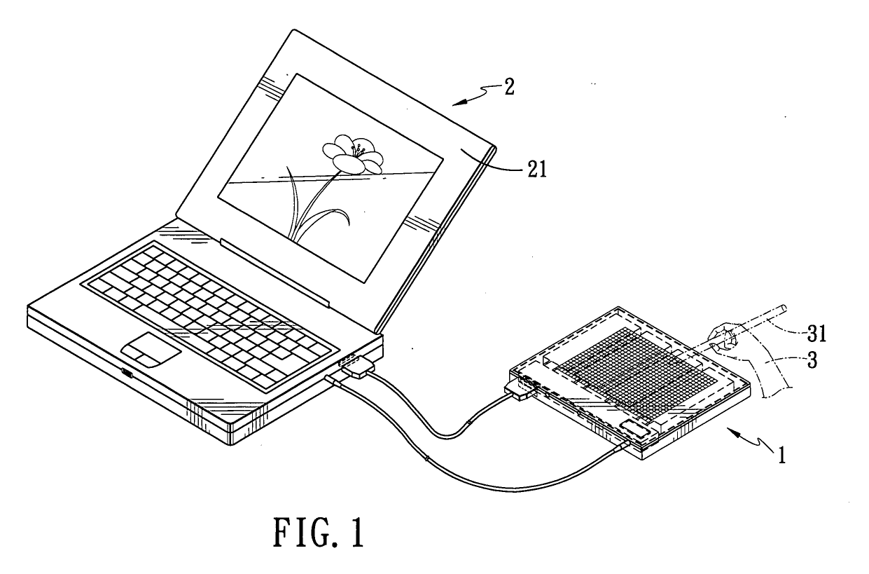

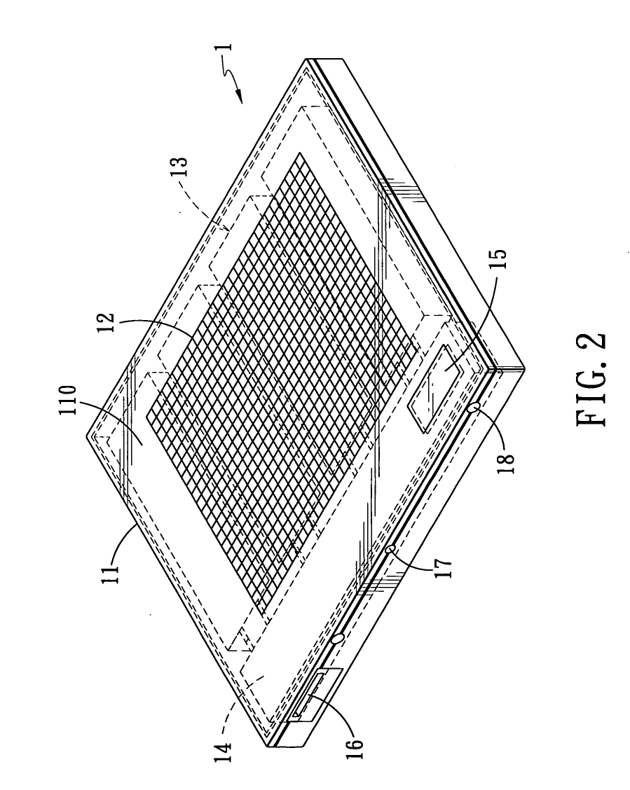

Referring to FIGS. 1 and 2, a combined digitizer tablet and external power supply device 1 according to a preferred embodiment of the present invention is electrically connected to an electronic apparatus 2, such as a laptop computer. The electronic apparatus 2 includes a monitor 21.

The combined digitizer tablet and external power supply device 1 according to the preferred embodiment of the present invention includes a housing 11, a sensing tablet unit 12, a battery unit 13, a control circuit 14, a display unit 15, a data communications unit 16, a power input unit 17, and a power output unit 18. The housing 11 has a working surface 110.

The sensing tablet unit 12 is disposed on the working surface 110 of the housing 11, and generates electrical signals (i.e., sensing signals) in response to writing activity thereon in a conventional manner. The sensing signals are typically generated by movement of a stylus 31 on the sensing tablet unit 12 by a user 3. After generation of the sensing signals, the sensing tablet unit 12 transmits the sensing signals to the control circuit 14. The sensing tablet unit 12 may be a resistive-type tablet, a capacitive-type tablet, or an inductive-type tablet.

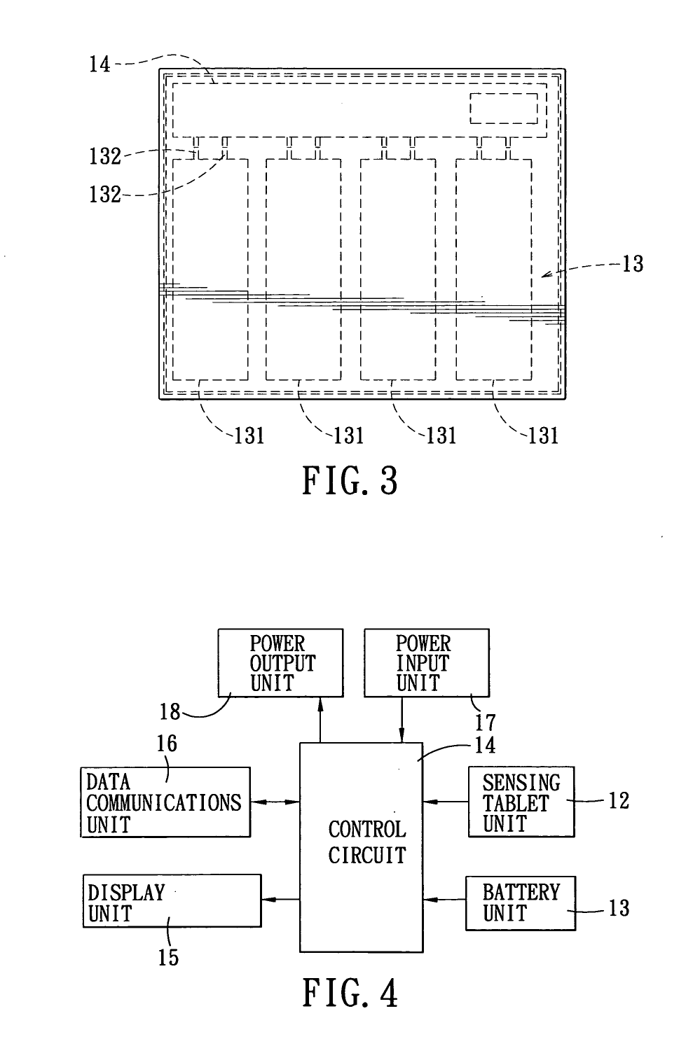

Referring to FIGS. 2 and 3, the battery unit 13 is mounted in the housing 11 and includes at least one battery cell 131. In the preferred embodiment, the battery unit 13 includes a plurality of the battery cells 131, and each of the battery cells 131 is rechargeable. The battery cells 131 may be lithium-ion (Li-ion) battery cells, nickel-metal hydride (Ni-MH) battery cells, lithium-polymer (Li-polymer) battery cells, nickel cadmium (Ni—Cd) battery cells, fuel cells, nickel-hydrogen (Ni—H) battery cells, etc.

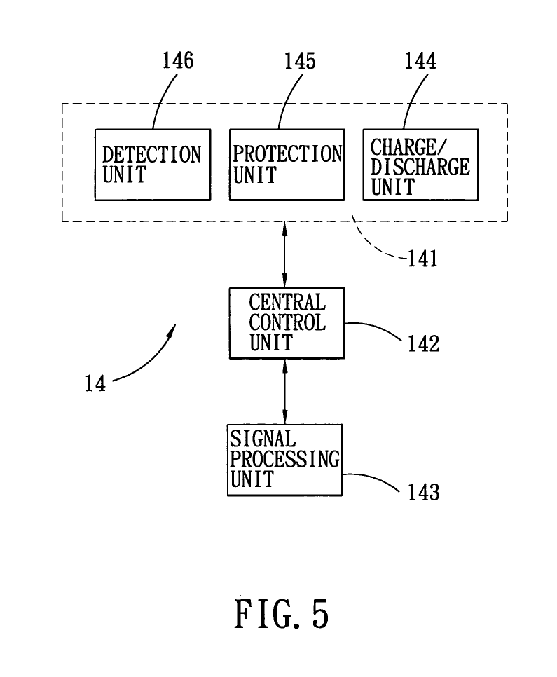

Referring to FIGS. 2, 4, and 5, the control circuit 14 is mounted in the housing 11. The control circuit 14 receives the sensing signals generated by the sensing tablet unit 12, converts the sensing signals into corresponding coordinate position data, and then transmits the coordinate position data to the electronic apparatus 2. The control circuit 14 is also responsible for display operation of the display unit 15 and power management of the battery unit 13. All of these operations of the control circuit 14 will be described in greater detail hereinafter.

The control circuit 14 includes a battery managing unit 141 coupled electrically to the battery unit 13 to manage the same, a signal processing unit 143 coupled electrically to the sensing tablet unit 12 to receive the sensing signals from the same, and a central control unit 142 coupled electrically to the signal processing unit 143 and the battery managing unit 141 to coordinate operations of the same. The battery managing unit 141 includes a charge/discharge unit 144, a protection unit 145, and a detection unit 146.

The charge/discharge unit 144 maintains voltage and current levels during charging and discharging of the battery unit 13 to within acceptable levels. The central control unit 142 controls the charging and discharging of the battery cells 131 of the battery unit 13 via the charge/discharge unit 144, and respectively via the power input unit 17 and the power output unit 18. The power input unit 17 is mounted on the housing 11, and is coupled electrically to the control circuit 14. The power input unit 17 is adapted to receive a charging signal for charging the battery cells 131. Each of the battery cells 131 includes a pair of terminals 132, and each terminal 132 is electrically coupled to the control circuit 14 such that the battery cells 131 are charged or discharged under the control of the control circuit 14. As with the power input unit 17, the power output unit 18 is mounted on the housing 11, and is coupled electrically to the control circuit 14. The power output unit 18 is operable to control the supply of battery power from the battery unit 13 to the electronic apparatus 2 (see FIG. 1).

The protection unit 145 of the battery managing unit 141 is used to protect the battery unit 13 by performing a cutting off operation when a temperature of the battery unit 13 exceeds a predetermined level, or when overvoltage and/or overcurrent problems occur in the battery unit 13.

The detection unit 146 detects battery status variables, such as voltage and capacity, and generates corresponding battery status signals. The detection unit 146 then transmits the battery status signals to the central control unit 142. The battery status signals generated by the detection unit 146 are processed by the central control unit 142, which then controls the display unit 15 to display battery status information thereon. The display unit 15 may be a liquid crystal display (LCD) or a light emitting diode (LED) display.

The signal processing unit 143 of the control circuit 14 receives the sensing signals transmitted by the sensing tablet unit 12, and performs analog-to-digital conversion of the sensing signals. The resulting digital signals are then transmitted to the central control unit 142, where the digital signals are converted into corresponding coordinate position data.

The data communications unit 16 is mounted in the housing 11, and is coupled electrically to the control circuit 14. The data communications unit 16 is adapted to establish a communications link with the electronic apparatus 2 so as to enable transmission of the coordinate position data from the central control unit 142 of the control circuit 14 to the electronic apparatus 2. The data communications unit 16 may establish a wired or wireless communications link with the electronic apparatus 2. The wired communications link may be a USB communications link or a 1394 communications link. The wireless communications link may be an infrared (IR) communications link or a radio frequency (RF) communications link.

In the combined digitizer tablet and external power supply device 1 of the present invention described above, an adverse affect on the portability of the electronic apparatus 2 is minimized by merging writing tablet and external battery pack capabilities into a single system. Further, the run time of the electronic apparatus 2 is increased by using the power of the battery unit 13 to operate the sensing tablet unit 12, rather than the internal batteries of the electronic apparatus 2.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

We claim:

1. A combined digitizer tablet and external power supply device for an electronic apparatus, comprising:
a housing having a working surface;
a sensing tablet unit disposed on said working surface of said housing and operable so as to generate electrical signals in response to writing activity thereon;
a battery unit disposed in said housing;
a control circuit coupled electrically to said sensing tablet unit and said battery unit, said control circuit receiving the electrical signals from said sensing tablet unit and generating coordinate position data corresponding to the electrical signals;
a data communications unit mounted in said housing, coupled electrically to said control circuit, and adapted to establish a communications link with the electronic apparatus so as to enable transmission of the coordinate position data from said control circuit to the electronic apparatus; and
a power output unit mounted on said housing, coupled electrically to said control circuit, and adapted to be coupled electrically to the electronic apparatus, said control circuit being operable so as to control supply of battery power from said battery unit to the electronic apparatus via said power output unit.

2. The combined digitizer tablet and external power supply device as claimed in claim 1, wherein:
said battery unit includes at least one rechargeable battery cell;
said combined digital tablet and power supply device further comprising a power input unit mounted on said housing, coupled electrically to said control circuit, and adapted to receive a charging signal;
said control circuit being further operable so as to control charging of said battery unit using the charging signal.

3. The combined digitizer tablet and external power supply device as claimed in claim 2, further comprising a display unit mounted on said housing, coupled electrically to said control circuit, and controlled by said control circuit to display battery status information thereon.

4. The combined digitizer tablet and external power supply device as claimed in claim 3, wherein said control circuit includes:
a signal processing unit coupled electrically to said sensing tablet unit and receiving the electrical signals therefrom;
a battery managing unit coupled electrically to said battery unit and operable so as to control charging and discharging of said battery unit and so as to detect battery status; and
a central control unit coupled electrically to said signal processing unit, said battery managing unit and said display unit,
said central control unit generating the coordinate position data corresponding to the electrical signals processed by said signal processing unit,
said central control unit further controlling the display of the battery status information on said display unit.

5. The combined digitizer tablet and external power supply device as claimed in claim 3, wherein said display unit is one of a liquid crystal display and a light emitting diode display.

6. The combined digitizer tablet and external power supply device as claimed in claim 1, wherein said data communications unit is adapted to establish a wired communications link with the electronic apparatus.

7. The combined digitizer tablet and external power supply device as claimed in claim 6, wherein the wired communications link is one of a USB communications link and a 1394 communications link.

8. The combined digitizer tablet and external power supply device as claimed in claim 1, wherein said data communications unit is adapted to establish a wireless communications link with the electronic apparatus.

9. The combined digitizer tablet and external power supply device as claimed in claim 8, wherein the wireless communications link is one of an infrared communications link and a radio frequency communications link.
